(19) United States
(12) Patent Application Publication
(10) Pub. No.: US 2012/0042744 A1
(43) Pub. Date: Feb. 23, 2012

(54) ORGAN TYPE ACCELERATION PEDAL ASSEMBLY EMPLOYING LINEAR BEARING

(76) Inventor: Sang Hoon Han, Seoul (KR)

(21) Appl. No.: 12/880,264

(22) Filed: Sep. 13, 2010

(30) Foreign Application Priority Data
Aug. 18, 2010 (KR) 10-2010-0079875

(51) Int. Cl. B60K 26/00; G05G 1/445

(52) U.S. Cl. 74/513

(57) ABSTRACT

An organ type acceleration pedal assembly includes a pedal pad that connected to a floor panel below a driver seat by a hinge and swings within a predetermined rotation angle range to accelerate a vehicle. A linear bearing mounted at the center of the rear surface of the pedal pad in a longitudinal direction of the pedal pad moves linearly with the swing of the pedal pad. A pedal arm rotationally fixed to a mounting bracket formed on a dash panel below the driver seat has one end connected to the linear bearing by a hinge so as to move forward and backward with the linear movement of the linear bearing, and another end that adjusts the switching of a throttle valve with the forward and backward movement of the one end.

### CROSS-REFERENCE TO RELATED APPLICATIONS

This application claims priority to and the benefit of Korean Patent Application No. 10-2010-0079875 filed on Aug. 18, 2010, the contents and teachings of which are hereby incorporated by reference in their entirety.

### BACKGROUND

1. Field of the Invention

The present invention relates to an organ type acceleration pedal assembly employing a linear bearing, and more particularly, to an organ type acceleration pedal assembly employing a linear bearing, which has a structure that a rear end of a pedal pad is fixed to a floor panel by a hinge so as to swing by a predetermined rotation angle and a pedal arm is connected to a linear bearing mounted on the rear center of the pedal pad in a longitudinal direction thereof by a hinge and in which the pedal arm connected to the pedal pad can efficiently adjust the switching of a throttle valve with the rotation displacement of the pedal pad swinging by a driver, thereby improving the operational convenience of a vehicle acceleration pedal and reducing a driver's foot fatigue.

2. Description of the Related Art

In general, an acceleration pedal is a kind of vehicle operating device which adjusts the revolving speed of an engine by adjusting amounts of fuel and air introduced into the engine by interlocking with a carburetor.

FIG. 1 is a diagram schematically illustrating the structure of a pendant type acceleration pedal assembly according to the related art.

Referring to FIG. 1, the pendant type acceleration pedal includes a pedal arm 10 that is rotationally coupled to a mounting bracket 30 protruding to the indoor side from a dash panel D below a driver seat with a swing shaft 32 interposed therebetween and a pedal pad 20 that is coupled to a first extension end 14 of the pedal arm 10 by a hinge 22 and that is operated by a driver's foot pressure.

In other words, when a driver presses the pedal pad 20, the first extension end of the pedal arm 10 connected to the pedal pad 20 by the hinge 22 moves forward and a second extension end 12 of the pedal arm 10 rotationally fixed to the swing shaft 32 moves backward.

The second extension end 12 of the pedal arm 10 has an interlocking structure that opens a throttle valve (not shown) at the time of moving backward and shutting the throttle valve at the time of moving forward.

Accordingly, the switching of the throttle valve can be actively adjusted with the pressurizing and depressurizing of the pedal pad 20, and the acceleration of the vehicle is smoothly adjusted with the driver's operation on the pedal pad 20.

However, in such a pendant type acceleration pedal, in the cases of collision and rear-end of vehicles, particularly, in the case of a vehicle accident where great impact power acts to destroy an engine room, the pedal arm 10 and the pedal pad 20 having a free end may beat a driver's shin to injure the driver. In addition, since the pedal pad 20 is separated upward from a floor panel F below the driver seat, there is a problem that the operational convenience of the pedal assembly is low.

The pedal pad 20 having the above-mentioned structure increases the driver's foot fatigue, thereby causing long-term drivers and professional drivers to have severe fatigue accumulation.

To solve such problems, an organ type acceleration pedal assembly in which the pedal pad 20 is rotationally fixed to the floor panel F below the driver seat is suggested, but is disadvantageous in that the manufacturing cost is high. Accordingly, such an organ type acceleration pedal assembly is restrictively applied to only some high-class cars, but is not applied to the other cars.

### SUMMARY

An advantage of some aspects of the invention is that it provides an organ type acceleration pedal assembly employing a linear bearing, which can improve the operational convenience of a vehicle acceleration pedal and reduce a driver's foot fatigue.

Another advantage of some aspects of the invention is that it provides an organ type acceleration pedal assembly employing a linear bearing, which can improve the operational convenience of an acceleration pedal and greatly reduce the manufacturing cost by employing an organ type structure for pressing the acceleration pedal and employing an existing pedal arm without any change.

According to an aspect of the invention, there is provided an organ type acceleration pedal assembly including: a pedal pad that is connected to a floor panel below a driver seat by a hinge and that swings within a predetermined rotation angle range at the time of pressing the pedal pad to accelerate a vehicle; a linear bearing that is mounted at the center of the rear surface of the pedal pad in a longitudinal direction of the pedal pad and that moves linearly with the swing of the pedal pad; and a pedal arm that is rotationally fixed to a mounting bracket formed on a dash panel below the driver seat, one end of which is connected to the linear bearing by a hinge so as to move forward and backward with the linear movement of the linear bearing, and the other end of which adjusts the switching of a throttle valve with the forward and backward movement of the one end.

Here, the linear bearing may include: a guide rail that is disposed at the center of the rear surface of the pedal pad in the longitudinal direction; and a moving block that slides along the guide rail in the longitudinal direction of the pedal pad and in which a friction reducing member is disposed in a contact area with the guide rail.

The friction reducing member may be a ball bearing assembly or a roller bearing assembly that is disposed in at least one line on both sides of the contact area of the guide rail with the moving block.

The guide rail may include a pair of end plates that protrudes from both ends in the longitudinal direction to form end protrusions so as to prevent the moving block from being separated from the guide rail. Here, a moving block displacement adjusting section including an elastic portion of which displacement is adjusted with an elastic force to restore the displaced moving block to an initial position and a displacement detector that detects the displacement of the elastic portion to detect the displacement of the moving block may be further disposed between the end plates and the moving block.

The organic type acceleration pedal assembly may further include: a data conversion unit that converts the displacement of the elastic portion detected by the displacement detector into a digital signal in an analog-to-digital conversion manner; a data computing unit that receives the digital signal from the data conversion unit and calculates a replacement period based on damage on the elastic portion; and a display unit that notifies a user of the replacement period of the elastic portion calculated by the data computing unit as visual information.

According to the above-mentioned configuration, the rear end of the pedal pad is fixed to the floor panel by a hinge so as to swing by a predetermined rotation angle and the pedal arm is connected to the linear bearing mounted at the center of the rear surface of the pedal pad to linearly move in the longitudinal direction by a hinge. Accordingly, the pedal arm can effectively adjust the switching of the throttle valve depending on the rotation angle of the pedal pad swinging by the driver's pressing, thereby improving the operational convenience of the vehicle acceleration pedal and reducing the driver's foot fatigue.

### BRIEF DESCRIPTION OF THE DRAWINGS

FIG. 1 is a diagram schematically illustrating the structure of a pendant type acceleration pedal assembly to the related art.

FIG. 2 is a diagram schematically illustrating the structure of an organ type acceleration pedal assembly employing a linear bearing according to an embodiment of the invention.

FIG. 3 is a diagram schematically illustrating an example where a pedal pad, a linear bearing, and a pedal arm interlock with each other to cause geometrical displacement at the time of pressing the organ type acceleration pedal assembly employing a linear bearing according to the embodiment of the invention.

FIG. 4 is a diagram schematically illustrating an example where the pedal pad, the linear bearing, and the pedal arm interlock with each other to cause geometrical displacement at the time of depressurizing the organ type acceleration pedal assembly employing a linear bearing according to the embodiment of the invention.

FIG. 5 is an enlarged view of a connection structure of the pedal pad and the linear bearing in the organ type acceleration pedal assembly employing the linear bearing according to the embodiment of the invention.

FIG. 6 is a diagram conceptually illustrating a linear bearing singly disposed on the rear surface of the pedal pad in the organ type acceleration pedal assembly employing the linear bearing according to the embodiment of the invention.

FIG. 7 is a diagram conceptually illustrating a linear bearing double disposed on the rear surface of the pedal pad in the organ type acceleration pedal assembly employing the linear bearing according to the embodiment of the invention.

### DESCRIPTION OF EXEMPLARY EMBODIMENTS

Hereinafter, an organ type acceleration pedal assembly employing a linear bearing according to exemplary embodiments will be described with reference to the accompanying drawings.

Advantages and features of the invention and methods for putting them into practice will be apparent from the following embodiments and drawings. However, the invention is not limited to the embodiments, but can be modified in various forms. The embodiments are provided to complete the disclosure of the invention and to completely notify the scope of the invention to those skilled in the art. Like reference numerals in the drawings reference like elements. When it is determined that detailed description of known techniques relating to the invention makes the gist of the invention obscure, the detailed description will be omitted.

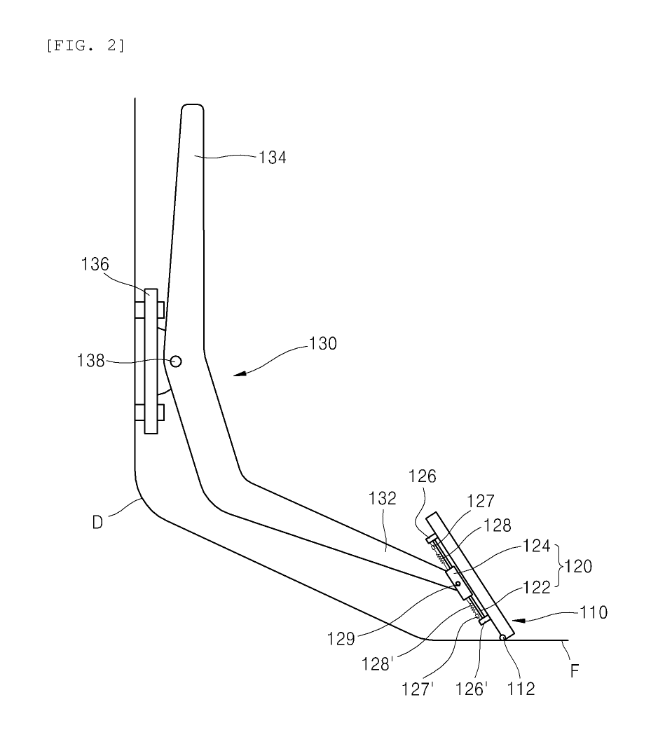

FIG. 2 is a diagram schematically illustrating the structure of an organ type acceleration pedal assembly employing a linear bearing according to an embodiment of the invention.

In the drawing, only some parts are clearly shown to conceptually understand the constituent relation of an exemplary embodiment of the invention. As a result, the drawing may be variously modified and thus the invention is not limited to drawing.

Referring to FIG. 2, organ type acceleration pedal assembly according to this embodiment includes a pedal pad 110 that swings with a driver's pressing and depressurizing of the pedal pad to accelerate a vehicle, a linear bearing 120 that is mounted at the center of the rear surface of the pedal pad 110 and that moves linearly with the swing of the pedal pad 110, and a pedal arm 130 that is connected to the linear bearing 120 by a hinge so as to adjust the switching of a throttle valve with the forward and backward movement thereof.

First, the pedal pad 110 will be described.

The pedal pad 110 is a member that is pressed by a driver to accelerate a vehicle. The lower end of the pedal pad 110 is connected to a floor panel F below a driver seat by a hinge 112.

That is, when the driver steps on the pedal pad 110 to apply a foot effort, the pedal pad 110 swings about the hinge 112 within a predetermined rotation angle range.

The pedal pad 110 is not limited to the shape and size shown in the drawing, and preferably has a length and a width greater than those of an adult foot. It is preferable that the driver's foot comes in non-slidable contact with the upper surface of the pedal pad 110 during driving the car, and thus uneven patterns may be additionally formed thereon.

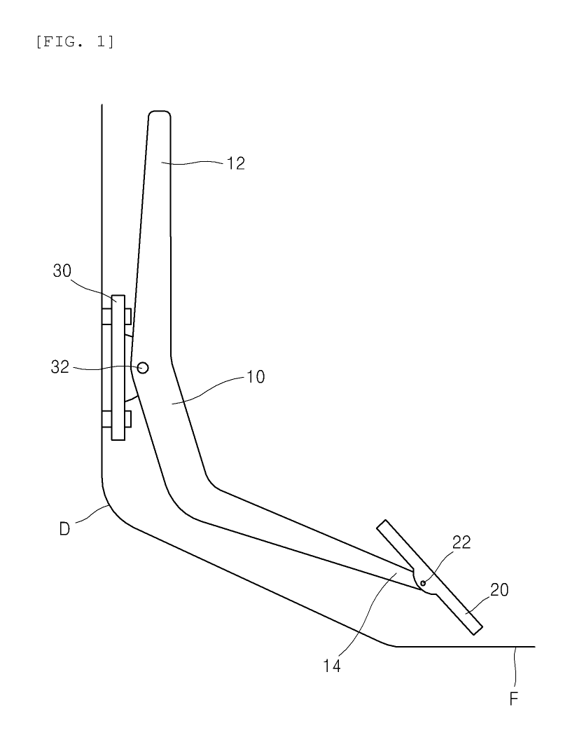

The pedal pad 110 according to this embodiment swings in a way different from that of the pedal pad 20 (FIG. 1) according to the related art. The pedal pad 20 has a typical shape of a pendant type acceleration pedal, and the pedal pad 110 according to this embodiment has an operation mechanism similar to that of the organ type acceleration pedal.

The operation mechanism of the pedal pad 110 according to this embodiment provides the merit of the organ type acceleration pedal, that is, the improvement in operational convenience of the pedal and the reduction of the driver's foot fatigue, and prevent the injury on the driver's body (particularly, the driver's shin) at the time of collision or rear-end of a vehicle because the pedal pad 110 is fixed to the floor panel F.

The linear bearing 120 is mounted at the center of the rear surface of the pedal pad 110 in the longitudinal direction of the pedal pad.

Then, the linear bearing 120 will be described.

The linear bearing 120 is a member that is arranged at the center of the rear surface of the pedal pad 110 in one or two or more lines in the longitudinal direction of the pedal pad 110 and that moves linearly with the swing of the pedal pad 110.

The linear bearing 120 includes a guide rail 122 disposed at the center of the rear surface of the pedal pad 110 in the longitudinal direction and a moving block 124 formed to slide in the longitudinal direction of the pedal pad 110 along the guide rail 122.

The moving block 124 preferably includes a friction reducing member in a contact area with the guide rail 122 so as to reduce the friction and thus to make the sliding movement more smooth.

The friction reducing member is not shown in the drawings, but may be a ball bearing assembly or a roller bearing assembly which is disposed in at least one line in both sides of the contact area between the guide rail 122 and the moving block 124. A variety of lubricant may be applied instead of the lubricating assembly.

The guide rail 122 may include a pair of end plates 126 and 126′ protruding from both ends in the longitudinal direction to form end protrusions so as to prevent the moving block 124 mounted on the guide rail 122 from being separated.

The outer edge of the end plates 126 and 126′ extends in all directions from the guide rail 122. The end plates 126 and 126′ serve to prevent the moving block 124 moving to both ends of the guide rail 122 from being separated therefrom.

A moving block displacement adjusting section 127, 127′, 128, and 128′ that adjusts the displacement of the moving block may be further disposed between the end plates 126 and 126′ and the moving block 124.

The moving block displacement adjusting section 127, 127′, 128, and 128′ gives a proper elastic force at the time of the linear movement of the moving block 124, and serves to restore the moving block 124 to an initial position when the foot effort acting on the pedal pad 110 is released, or to reduce the vibration based on the linear movement of the moving block 124 when a sudden foot effort acts on the pedal pad 110.

The moving block displacement adjusting section 127, 127′, 128, and 128′ includes elastic portions 128 and 128′ of which the displacement is adjusted with an elastic force to restore the displaced moving block 124 to the initial position and displacement detectors 127 and 127′ that detects the displacement of the elastic portions to detect the displacement of the moving block 124.

An elastic body such as a spring having a constant spring constant can be used as the elastic portions 128 and 128′, and an elastic body having a variable modulus of elasticity may be preferably used.

Here, the elastic body having a variable modulus of elasticity means a member that changes the modulus of elasticity by filling the inner hollow of the elastic body with ER (Electro-Rheological) fluid or with expensive MR (magneto-Rheological) fluid for a more increase in performance and applying electricity to both ends of the elastic body.

By employing the elastic body having a variable modulus of elasticity as the elastic portions 128 and 128′, it is possible to realize excellent operational convenience in consideration of features of drivers applying a foot effort on the pedal pad 110.

The displacement detectors 127 and 127′ mean sensing members that detect the displacements of the elastic portions 128 and 128′ so as to detect the displacement of the moving block 124, and can be connected to the elastic portions 128 and 128′.

A load cell, a pressure sensor, and the like can be used as the displacement detectors 127 and 127′.

A damper is additionally disposed on one side of each displacement detector 127 and 127′. Accordingly, it is possible to effectively damp the vibration resulting from the displacement of the moving block 124, thereby realizing a stable operation of the pedal.

According to this configuration, the linear bearing 120 can move linearly in the longitudinal direction at the center of rear surface of the pedal pad 110 with the swinging of the pedal pad 110, when the pedal pad 110 swings within a predetermined rotation angle range by the driver's pressing.

On the other hand, the moving block 124 of the linear bearing 120 is connected to an end 132 of the pedal arm 130 by a hinge so as to move by interlocking therewith.

Then, the pedal arm 130 will be described.

The pedal arm 130 is a member of which the center of an arc body is fixed to a mounting bracket 136 coupled to a dash panel D below the driver seat by a swing shaft 138, an end (hereinafter, referred to as “first end”) 132 extending to one side is connected to the moving block 124 of the linear bearing 120 by a hinge, and the other end (hereinafter, referred to as “second end”) 134 extending to the other side is formed to interlock with the switching operation of a throttle valve (not shown).

Because of these shape and structural feature of the pedal arm 130, when the moving block 124 of the linear bearing 120 moves linearly, the first end 132 of the pedal arm 130 moves forward and backward and the second end 134 of the pedal arm 130 moves in the opposite direction of the forward or backward direction of the first end 132 to adjust the switching of the throttle valve.

The pedal arm in the existing pendant type acceleration pedal assembly can be used as the pedal arm 130 in the invention. Accordingly, additional manufacturing cost and design cost are not required, which is economic. In addition, standardized components are first manufactured and are then applied to various vehicles, thereby enhancing utilization of generally-used components.

However, the first end 132 is preferably longer than that of the existing pedal arm. This is because it can be easily connected to the pedal pad 110 rotationally fixed to the floor panel F and the linear bearing 120 disposed on the rear surface thereof.

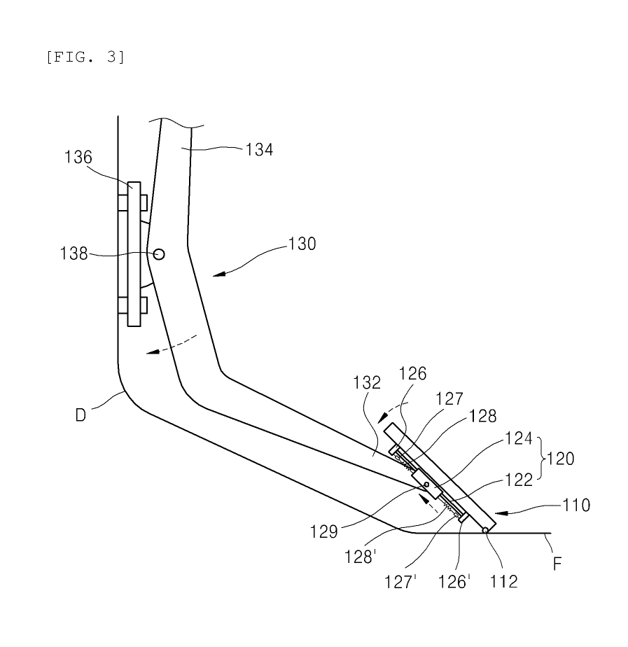

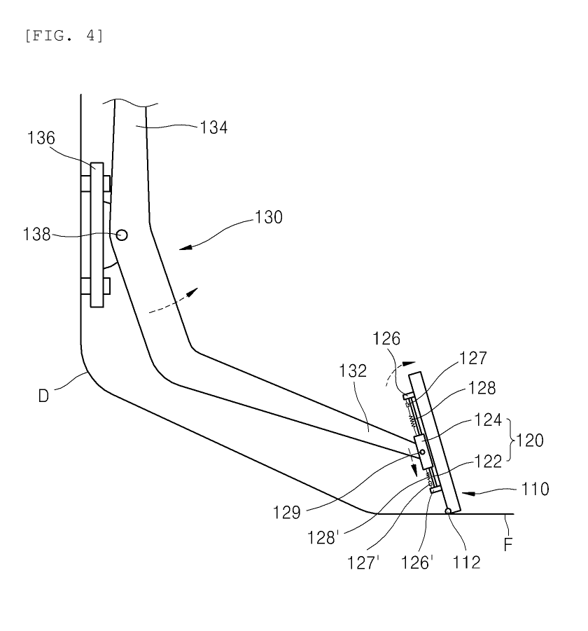

Operations and advantages of the organ type acceleration pedal assembly employing a linear bearing according to the embodiment of the invention will be described with reference to FIGS. 3 and 4.

FIG. 3 is a diagram schematically illustrating an example where the pedal pad, the linear bearing, and the pedal arm interlock with each other to cause geometrical displacement at the time of pressing the organ type acceleration pedal assembly employing a linear bearing according to the embodiment of the invention. FIG. 4 is a diagram schematically illustrating an example where the pedal pad, the linear bearing, and the pedal arm interlock with each other to cause geometrical displacement at the time of depressurizing the organ type acceleration pedal assembly employing a linear bearing according to the embodiment of the invention.

Referring to FIG. 3, it is shown that a driver swings forward the pedal pad 110 to accelerate a vehicle.

The pedal pad 110 to which a driver's foot effort is applied swings forward above the hinge 112, which is a swing point on the floor panel F, within a predetermined rotation angle range.

With the swinging of the pedal pad 110, the moving block 124 of the linear bearing 120 compresses an upper elastic portion 128 formed between an upper end plate 126 of the guide rail 122 and the moving block and extends a lower elastic portion 128′ formed between a lower end plate 126′ of the guide rail 122 and the moving block, whereby the moving block 124 moves linearly upward.

With the upward linear movement of the moving block 124, the first end 132 of the pedal arm 130 connected to the moving block 124 by a hinge moves forward and the second end 132 of the pedal arm 130 of which the body center is fixed by the swing shaft 138 moves in the opposite direction of the moving direction of the first end 132.

At this time, with the backward movement of the second end 132 of the pedal arm 130, the throttle valve (not shown) connected to the second end to interlock therewith is opened. Accordingly, the amounts of fuel and air introduced into a carburetor become greater, thereby accelerating the vehicle.

In FIG. 4, it is shown that the acceleration of the vehicle is stopped when the driver's foot effort on the pedal pad 110 is released.

The pedal pad 110 from which the foot effort is removed swings backward about the hinge 112, which is the swing point on the floor panel F, within a predetermined rotation angle range.

The backward swinging of the pedal pad 110 is carried out by the restoring force of the upper and lower elastic portions 128 and 128′ in the linear bearing 120. The force acting on the pedal pad 110 from which the foot effort is removed includes only the restoring force of the upper elastic portion 128 compressed with the movement of the moving block 124 and the restoring force of the lower elastic portion 128′ extending when the foot effort acts just before.

Therefore, the moving block 124 is restored to the initial position with the restoring forces of the upper and lower elastic portions 128 and 128′ and the pedal pad 110 coupled to the linear bearing 120 including the moving block 124 also swings to the initial position.

With the restoration of the moving block 124 to the initial position, the first end 132 of the pedal arm 130 connected to the moving block by the hinge 129 to interlock therewith moves backward and the second end 134 of the pedal arm 130 moves forward, whereby the throttle valve (not shown) is shut. Accordingly, the amounts of fuel and air introduced into the carburetor are reduced or zero, thereby decelerating the vehicle.

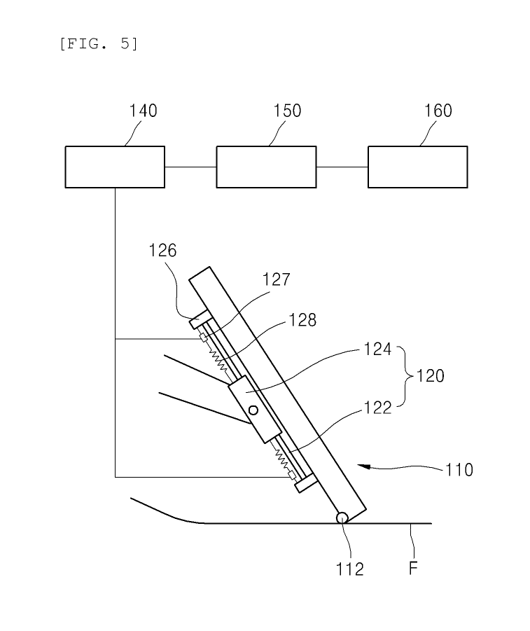

FIG. 5 is an enlarged view of a connection structure of the pedal pad and the linear bearing in the organ type acceleration pedal assembly employing the linear bearing according to the embodiment of the invention.

In FIG. 5, the connection structure of the pedal pad and the linear bearing according to the embodiment of the invention is shown in detail.

Here, according to an exemplary embodiment of the invention, the displacement of the elastic portion 128 detected by the displacement detector 127 in the linear bearing 120 is subjected to a data converting process and a computing process and is then notified to a user, particularly, a vehicle driver, as visual information, thereby monitoring the displacement.

The organ type acceleration pedal assembly includes a data conversion unit 140 that converts the displacement of the elastic portion 128 detected by the displacement detector 127 into a digital signal, a data computing unit 150 that receives the digital signal from the data conversion unit 140 and calculates a replacement period based on damage of the elastic portion, and a display unit 160 that notifies a user of the replacement period of the elastic portion calculated by the data computing unit 150.

Accordingly, it is possible to effectively detect the operational precision of the pedal pad 110 with which a predetermined displacement is caused in the rotation angle by the driver's foot effort and the precision error of the linear bearing 120 moving linearly by a predetermined displacement with the displacement in rotation angle of the pedal pad 110. As a result, it is possible to more precisely measure the operation state of the acceleration pedal, thereby guaranteeing the stability in driving a vehicle and the operational convenience to a user.

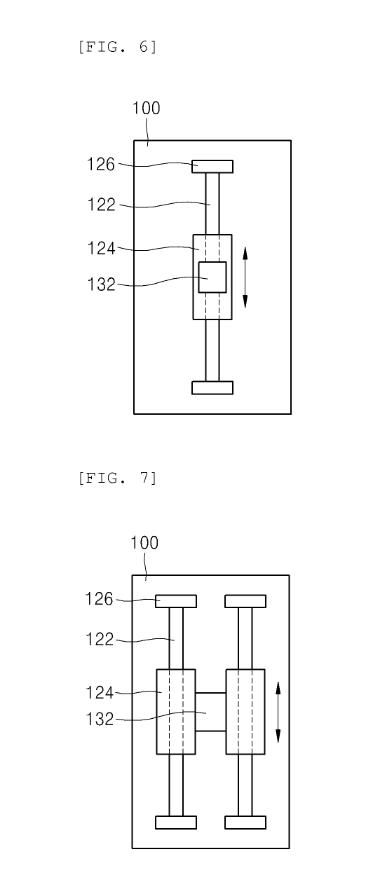

FIG. 6 is a diagram conceptually illustrating a linear bearing singly disposed on the rear surface of the pedal pad in the organ type acceleration pedal assembly employing the linear bearing according to the embodiment of the invention. FIG. 7 is a diagram conceptually illustrating a linear bearing double disposed on the rear surface of the pedal pad in the organ type acceleration pedal assembly employing the linear bearing according to the embodiment of the invention.

The linear bearing described above with reference to FIGS. 2 to 5 is singly disposed in the longitudinal direction of the pedal pad 110 at the center of the rear surface of the pedal pad 110 as shown in FIG. 6, but the invention is not limited to this configuration. For example, as shown in FIG. 7, the linear bearing may be double disposed on the rear surface of the pedal pad 110.

In the single linear bearing shown in FIG. 6, a single guide rail 122 is disposed in the longitudinal direction at the center of the rear surface of the pedal pad 110 and the end plates 126 are formed at both ends thereof. A single moving block 124 is mounted on the guide rail 122 so as to linearly move along the center of the guide rail 122.

The first end 132 of the pedal arm is connected to one side of the moving block 124, whereby the pedal arm performs a desired action with the movement of the moving block 124.

In the double linear bearing shown in FIG. 7, two guide rails 122 are disposed in parallel in the longitudinal direction of the pedal pad 110 so as to be separated by a predetermined gap from the center of the rear surface of the pedal pad 110 and the end plates 126 are formed at both ends of each guide rail.

Two moving blocks 124 mounted at the center of the guide rails 122 and connected to each other move linearly together.

At this time, the first end 132 of the pedal arm can be connected to the connecting portion of the moving blocks 124, that is, the center thereof. Accordingly, the pedal arm can perform the desired action with the linear movement of the moving blocks 124.

Hitherto, the organ type acceleration pedal assembly employing a linear bearing according to the exemplary embodiments of the invention is described.

It should be understood that the above-mentioned embodiments are only for exemplification but are intended to limit the invention, that the scope of the invention is defined by the appended claims, not the above description, and that spirit and scope of the claims and all changes or modifications derived from equivalents thereof belong to the scope of the invention.

What is claimed is:

1. An organ type acceleration pedal assembly comprising:
a pedal pad that is connected to a floor panel below a driver seat by a hinge and that swings within a predetermined rotation angle range at the time of pressing the pedal pad to accelerate a vehicle;
a linear bearing that is mounted at the center of the rear surface of the pedal pad in a longitudinal direction of the pedal pad and that moves linearly with the swing of the pedal pad; and
a pedal arm that is rotationally fixed to a mounting bracket formed on a dash panel below the driver seat, one end of which is connected to the linear bearing by a hinge so as to move forward and backward with the linear movement of the linear bearing, and the other end of which adjusts the switching of a throttle valve with the forward and backward movement of the one end.

2. The organ type acceleration pedal assembly according to claim 1, wherein the linear bearing includes:
a guide rail that is disposed at the center of the rear surface of the pedal pad in the longitudinal direction; and
a moving block that slides along the guide rail in the longitudinal direction of the pedal pad and in which a friction reducing member is disposed in a contact area with the guide rail.

3. The organ type acceleration pedal assembly according to claim 2, wherein the friction reducing member is a ball bearing assembly or a roller bearing assembly that is disposed in at least one line on both sides of the contact area of the guide rail with the moving block.

4. The organ type acceleration pedal assembly according to claim 2, wherein the guide rail includes a pair of end plates that protrudes from both ends in the longitudinal direction to form end protrusions so as to prevent the moving block from being separated from the guide rail, and
wherein a moving block displacement adjusting section including an elastic portion of which displacement is adjusted with an elastic force to restore the displaced moving block to an initial position and a displacement detector that detects the displacement of the elastic portion to detect the displacement of the moving block is further disposed between the end plates and the moving block.

5. The organic type acceleration pedal assembly according to claim 4, further comprising:
a data conversion unit that converts the displacement of the elastic portion detected by the displacement detector into a digital signal in an analog-to-digital conversion manner;
a data computing unit that receives the digital signal from the data conversion unit and calculates a replacement period based on damage on the elastic portion; and
a display unit that notifies a user of the replacement period of the elastic portion calculated by the data computing unit as visual information.
